(19) United States
(12) Patent Application Publication
(10) Pub. No.: US 2004/0006535 A1
(43) Pub. Date: Jan. 8, 2004

(54) Wireless demand validation system

(76) Inventors: Joseph W. Forbes JR., Wake Forest, NC (US); Peter O. Roach JR., Atlanta, GA (US)

Correspondence Address: MEHRMAN LAW OFFICE, P.C., ONE PREMIER PLAZA, 5605 GLENRIDGE DRIVE, STE. 795, ATLANTA, GA, 30342, US

(21) Appl. No.: 10/608,596

(22) Filed: Jun. 27, 2003

Related U.S. Application Data
(60) Provisional application No. 60/392,339, filed on Jun. 27, 2002.

(51) Int. Cl. G06F 17/60

(52) U.S. Cl. 705/38

(57) ABSTRACT

Methods and apparatus are provided for developing and deploying a wireless market demand validation system (“WDVS”). This system allows a mobile network operator to prevalidate any demand in a given coverage area before expensive wireless network infrastructure is deployed. The WDVS replicates the necessary over the air functions of a full mobile system in order to create an environment where a wireless subscriber device will attempt a registration onto the WDVS. The WDVS will then capture this information and further instruct the wireless subscriber device to tune to another network. With this information the wireless network operator can then determine the potential demand as well as the cost effectiveness of deploying a full wireless network. The system may also be used to evaluate potential base station locations and select preferred base station locations based on the measured performance of the test radio at each location.

### REFERENCE TO RELATED APPLICATIONS

This application claims priority to commonly-owned U.S. Provisional Patent Application Serial No. 60/392,339, entitled “Market Potential Test System” filed on Jun. 27, 2002.

### TECHNICAL FIELD

The present invention relates generally to a radio communications network and more particularly to the installation and market validation of the need for additional radio base station infrastructure in a wireless communications network.

### BACKGROUND OF THE INVENTION

Currently in the United States much of the country is served by either an analog wireless system or a digital wireless system. A number of the major mobile operators in the United States have announced plans to overlay or upgrade these legacy wireless systems with a more advanced Global System for Mobile Communications (“GSM”) digital wireless system. The mobile operators are performing these upgrades for several reasons, including cost. Since GSM wireless systems are used across most of the world the manufacturers of the infrastructure equipment and headsets have achieved very favorable economies of scale and can produce the GSM equipment very efficiently. Standards are another factor driving the upgrade to GSM. Specifically, ETSI (European Telecommunications Standards Institute) has developed very detailed GSM standards that strictly define the interfaces between all of the components of the system. This allows a mobile operator to choose which manufacturers will supply individual components of the system. Unlike the analog or TDMA standard where a mobile operator is forced to purchase the entire system from a single manufacturer. Due to the penetration of GSM technology and its strong foundation in standards, GSM has a well defined future growth path. This growth path will allow mobile operators to easily provide the advanced services required by the market.

While the legacy systems are being upgraded in most of the major metropolitan cities, the mobile operators are being very careful about providing GSM coverage in many of the less populated areas. This is due to a number of reasons. First the mobile infrastructure needed to offer service in many rural areas is cost prohibitive for the anticipated demand. Second, the legacy analog wireless system can provide a much larger coverage area. This allows the analog system to use a single radio transmitter and tower structure to provide service where it would require numerous GSM cell sites to provide comparable service. Third, due to this smaller coverage area, it is difficult to determine how much GSM infrastructure is really needed to cover the anticipated demand. As stated, the analog cell site coverage is often much larger and covers more area. Due to the cost of deployment, the smaller GSM coverage may only cover a portion of the area. This forces the network operator to determine which portions of the formerly covered area has enough anticipated demand to cost justify the investment in infrastructure.

The mobile operators usually rely on standard demographic modeling and mapping tools to determine anticipated demand. This is an inexact science and often results in over deployment of infrastructure or the deployment of infrastructure where demand does not really exist. Finally, there is no easy method of determining the exact amount of traffic and the traffic mix. In a wireless system that offers mobility there are a number of different types of traffic; e.g., normal home subscribers, home business subscribers, home subscribers with large inexpensive flat rate minutes plans, roaming subscribers, etc. It is highly desirable to first deploy wireless infrastructure where the highest value customers are most likely to travel. This would allow a wireless network operator to gain the most advantage from its network infrastructure deployment.

In addition to the need to upgrade the existing system from analog to GSM or another advanced wireless system, there is also a great deal of land area without wireless coverage or that is not covered by a particular wireless operator. The demand in many of these areas is currently undefined since the user is unable to make a call in this area. This factor when combined with the ever increasing size of the population and the geographic dispersal of the housing means there is often a large demand for wireless service in an area that is currently untapped.

Since wireless communications is often a convince type item, if particular geography is not covered by a wireless system the user does not normally save the conversation for a later date. For example users may call someone on a long trip in order to pass the time but they often do not save this conversation for later or if wireless coverage is not available. If the user does saver the conversation for later, typically they may be more rushed for time and are likely to have a much shorter conversation.

In summary, often the mobile operator has a license to offer an advanced wireless system in a designated area, but due to perceived market conditions, will choose to allow their customers to roam onto an existing network or go without service. The mobile operators usually have long term plans to upgrade these systems, however, with the tools available today they usually cannot justify the capital, expenses, or manpower to upgrade these systems. In addition, at presently there is no cost effective way to assess the market potential of territory for wireless service. As a result, many areas that could support the installation of wireless communication equipment continue to go without wireless service due to the inability to effectively measure the market potential of the service area for wireless service and thereby justify the capital investment needed to bring wireless service to the area. Accordingly, a continuing need exists for improved methods and systems for assessing the market potential of service areas for wireless services.

### SUMMARY OF THE INVENTION

The present invention meets the needs described above through the use of a wireless telephone system test radio and a business model for using the radio. The wireless telephone system test radio preferably operates in send and receive modes in the GSM allocated signaling channel frequency range. However, the radio may also or alternatively operate in any or all of the CMRS frequency ranges, including the analog wireless, TDMA, CDMA, EDGE, WCDMA, or other desirable ranges. One skilled in the art can also see how the present invention can also be applied to IEEE 802.11, IEEE 802.16, IEEE 802.20 networks. The test radio should have adjustable gain and be set to transmit at the maximum allowable power level for the wireless site where the test is to be conducted under the prevailing FCC (U.S.) or EU (Europe) standard.

The test radio is typically portable and may operate with previously installed or a dedicated mobile antenna, which may be temporarily mounted on an existing tower, rooftop or other suitable location during the test. The test radio is configured to transmit autonomous registration signals on the forward download channel, and then receive registration messages from responding, wireless units. In response to a receive registration message, the test radio preferably transmits a reply message indicating that registration is not available for the responding wireless unit or the wireless network is not available for processing calls. The response messages obtained from the wireless units are then analyzed to determine the apparent number of wireless units operating in the relevant geographic area. For example, the test radio may transmit GSM registration signals, and count the responding wireless units, to obtain a measure of the number of GSM wireless units operating in the geographic area reached by the test radio. In this manner, the test radio can pole a particular geographic area for wireless units responding to a particular type of registration signal. Of course, the test radio may pole the geographic area for wireless units operating in several frequency ranges, such as analog wireless, TDMA, and GSM.

The test radio operates in connection with a host computer system that stores information received from the responding wireless units in order to create a database containing relevant information about the responding units. Typically, the information obtained from the unit's registration message includes the unit's MSISDN (directory number), its equipment ID (indicating the type of wireless unit), the unit's home system ID, and an ID indicating the last system on which the unit was registered. The host computer system may then use this information to obtain additional information about the unit over the wireless system, the Advanced Intelligent Network (AIN), the signaling system (SS7), the Internet, or other communication media.

For example, the host computer system may contact the unit's home system via the SS7 network to obtain information about the unit contained in the Home Location Register (HLR), such as a customer profile, registration history, and the like. The host computer system may also contact the manufacturer of the unit via the Internet to obtain information about the operating capabilities of the unit, such as the frequency ranges on which the unit may operate, the features of the unit, capabilities of the unit, or original purchaser of the unit. In this manner, the host computer system may determine, for example, if a unit responding on the GSM wireless frequency is TDMA compatible. The host computer system may also contact the wireless system clearinghouse via the SS7 network to obtain additional information about the unit, such as its air time history, payment history, and so forth. Additional information may be gathered from other locations, such as a credit report server, a commercial data server, and so forth. The test radio may then be moved to other locations to conduct similar poling and information gathering throughout a region of interest. All of the gathered information is then stored to create a robust database of information corresponding to the responding wireless units.

The business model of the present invention includes using the test radio to identify and implement business opportunities and conduct market and financial analyses. For example, rural areas may be polled to identify areas that have sufficient GSM and GSM compatible units to justify the installation of a GSM infrastructure. In particular, multiple discrete rural areas may be identified and grouped together into a combined GSM service area to gain the benefits of scale, such as purchasing wireless air time in wholesale blocks, obtaining GSM service to avoid roaming charges imposed by local carriers, or other business opportunities. This type of service option may be particularly advantageous for identifying rural pockets where GSM service is justified to avoid roaming charges imposed by local carriers when providing service to customers operating under a nation-wide flat-rate plan.

The database of information concerning a particular system's wireless units may also be used for a wide range of purposes, such as conducting market analysis, conducting feasibility studies for construction options, implementing marketing programs, designing wireless service plans, and so forth. For example, the information may also be used to implement direct marketing (e.g., push model) programs, incentive programs for the unit's owners, and the like. As an example, the system may be used to identify wireless units that are presently operating on the wireless TDMA frequency, but are configured to operating the GSM frequency. The system may then contact these units with an incentive offer to switch to GSM service. This type of contact may be initiated direct mail, placing a telephone call to the wireless unit, sending a short message (e.g., SMS, WAP or other available protocol) to the unit, or sending an e-mail to the unit's owner (if that information was gathered during the information gathering phase). In addition, the information in the database may be used to conduct marketing studies to design the incentive program.

The invention may also be used to evaluate potential wireless base station locations, and to select a preferred location from two or more potential locations under evaluation. In particular, the wireless test radio configured to mimic the air interface of a wireless communication system interface may be deployed at a first potential base station location. The test radio then transmits autonomous registration signals from the first potential base station location to wireless units and receives a first set of registration messages from responding wireless units and information associated with the first set of registration messages is stored in a database. Similarly, the test radio is deployed at a second potential base station location and transmits autonomous registration signals from the second potential base station location to wireless units. The test radio then receives a second set of registration messages from responding wireless units, and information associated with these registration messages is likewise stored in the database. The host computer system then analyzes the information stored in the database to determine whether the first or second potential base station locations is a preferred base station location. In addition, the test radio typically causes each responding wireless unit to seek registration with a different wireless system after receiving the registration message from the responding wireless unit, for example by transmitting a reply message indicating that the responding uit cannot register for wireless service through the test radio.

Many other uses of the test unit and the database will become apparent to those skilled in the wireless communications art. In view of the foregoing, it will be appreciated that the present invention avoids meet a current need for a wireless market potential validation system. The specific techniques and structures for implementing the invention, and thereby accomplishing the advantages described above, will become apparent from the following detailed description of the illustrative embodiments of the invention and the appended drawings and claims.

### BRIEF DESCRIPTION OF THE DRAWINGS

FIG. 1 is a conceptual diagram of a prior art wireless network.

FIG. 2 is a conceptual diagram a wireless network with a wireless demand validation system according to an embodiment of this invention.

FIG. 3 is a block system diagram of wireless demand validation system.

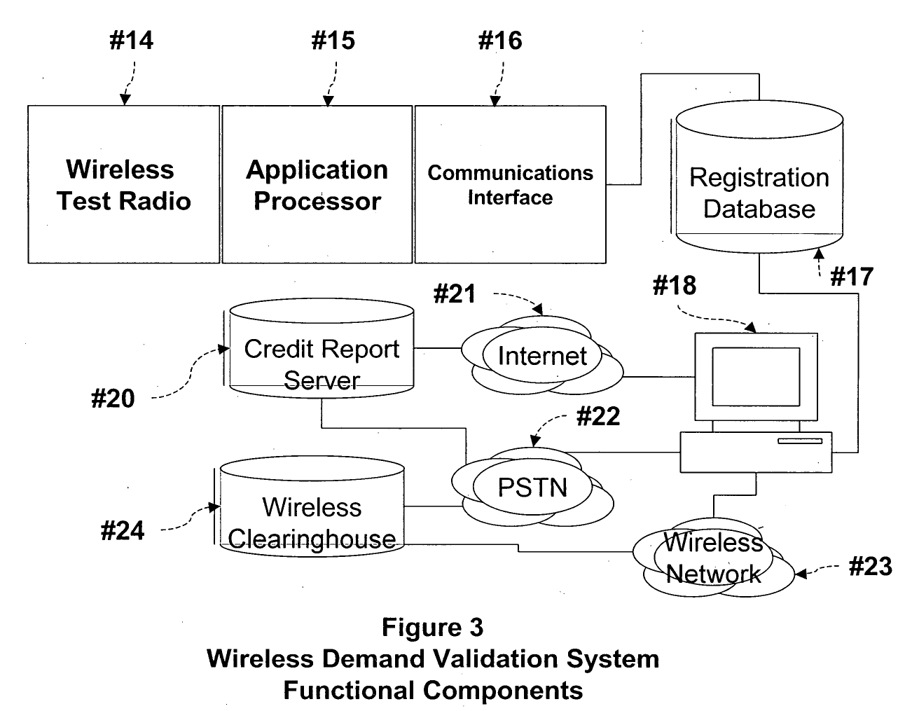

FIG. 4 is block system diagram of a wireless demand validation system mounted at existing tower sites to determine best server for a network.

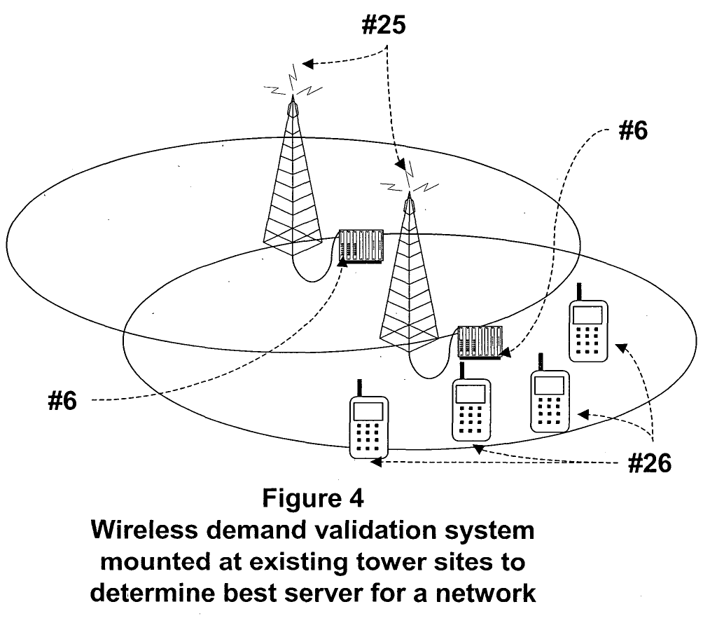

### DETAILED DESCRIPTION OF EXEMPLARY EMBODIMENTS

The present invention may be deployed as a wireless demand validation system that solves the problems of the prior art by providing an apparatus and method for developing and deploying a system that mimics the air interface of a standard mobile system (WDVS). It is envisioned that the WDVS would allow a new wireless device entering the coverage area of the WDVS to recognize the system, register on the system, and then be instructed that the system was not functioning properly. This sequence would allow a wireless device to register its presence with the WDVS. The WDVS would then take the information about the wireless device and store it in a database. The WDVS could then optionally further interrogate the wireless device to determine the device's equipment identification, service provider, or any other areas of information that might be interesting to the wireless network operator. The WDVS may then send a signal to the wireless device instructing it that the WDVS's network was either in distress or not available for traffic. Alternatively, the wireless network may change forbidden list in the wireless device, discontinue transmission to the wireless device for a specified period of time, instruct the wireless device to retune to another network, or implement any other suitable action that causes the wireless device to tune to another wireless network if one was available.

The wireless demand validation system allows a mobile operator to use the information gathered by the WDVS and stored in the database to determine raw traffic counts, counts of particular types of wireless devices, services equipped on the wireless devices, customer type, original network provider, or any other information stored in the wireless device. This information is then stored in a database for a large number of poled wireless units. The database, in turn, allow a wireless network operator to analyze this information against other information stored in other databases to determine a great deal more about the service subscriptions, habits, capabilities, and utilization patterns of the wireless device.

In this manner, the wireless demand validation system allows the network operator to determine the potential traffic available in a specified area before making the investment decision to place the network infrastructure and backhaul facilities in place to operate a full wireless network. The wireless demand validation system may be further improved by adding the functionality to the test radio to monitor the other network signaling channels. If another network was in place, this would enable the operator of the WDVS to obtain a better indication of how many wireless calls, data sessions, short messages, or any other type of transactions each mobile made. Since the test radio already knows the identity of the wireless device and many other wireless systems use the same identification when a wireless device first initiates a session with the network, these two databases could be compared to determine the potential number of calls or other wireless session for individual subscribers or mobile operators.

The wireless demand validation system may also have the capability to monitor individual traffic carrying channels would add the capability of determining the duration of individual phone calls. This further increases the accuracy of the forecast of potential traffic on the proposed network. In addition, if the signaling channels are know for the surrounding operational wireless network sites, instead of denying service on the wireless network, the test radio could instruct the wireless device to tune to the signaling channel for the desired network directly (directed retry). This action could be performed when the wireless device first initiates contact with the network or alternatively it could be performed when the wireless device requested a traffic channel on the wireless network. In this manner, the test radio could override the normal search routine of mobile phones or wireless devices. Using this method the WDVS can direct traffic onto the desired mobile system and potentially reduce the search time for the mobile or to switch the mobile onto the desired network directly or alternatively the WDVS could be used as a wireless traffic director in an area where the wireless network operator did not desire to install a full wireless system.

Further, instead of rejecting the registration attempt, the WDVS could allow the mobile to register on its network and then request information about the equipment type and services provisioned in the wireless device. With a GSM mobile network, for example, the WDVS could instruct the GSM mobile to return the IMEI (international mobile equipment identity) (MAP_Obtain_IMEI) of the mobile equipment. This provides the WDVS with the mobile equipment identification. From this identification, one can work with the mobile equipment manufacturers to determine the features of the mobile devices, such as EDGE, GPRS (both are data services), MMS (multimedia messaging service), WCDMA, etc. This information typically assists in planning which type of advance features to deploy in the GSM system. Once the IMEI is obtained from the mobile, the test equipment typically cancels the registration for the mobile, which causes the wireless device to register to an active wireless system in the service area, if available.

It should also be understood that, since the WDVS will only be designed to operate on a limited number of channels and would be operating in a somewhat clear radio spectrum, the wireless WDVS's power output could be substantially higher than base stations in the normal wireless network as interference with other base stations would be of less of a concern. This would allow the WDVS to have a substantially larger foot print than the other wireless bases stations in the operational network surrounding the WDVS. In that manner, a single WDVS could be utilized to determine the traffic requirements for several typical base stations. Also, a many network search algorithms contained in wireless, devices utilize received power as a significant variable in determining the preferred network. Therefore, transmitting at a higher power level gives the WDVS a much greater chance of first capturing and recording the traffic entering a specified area.

There may be other methods employed to achieve a similar same business result. For example, a simple method would be for the mobile operators to jointly examine mobile billing records to determine which mobile subscribers roamed into particular mobile systems. There are a number of logistical and business issues with this method. For example, the GSM operator would need to compare the billing record with the phone type of the user to determine if-the mobile is GSM enabled. In addition, this information often changes as users purchase new phones. Moreover, AMPS/TDMA systems generally cover a large area and the GSM operator may only desire to target one town or small geographic area. As a result, the data represented by the billing records would not necessarily be a good match for the desired coverage footprint.

As another alternative, the visited TDMA/Analog mobile operators in the target areas could maintain an equipment identity register (EIR). This would allow them to determine the mobile's serial number. They could then compare these serial numbers to mobile phone manufacture's records that would indicate the features available on that particular phone. Because the proposed system allows a competing wireless network provider to determine where to overlay a competing system, however, the existing wireless network provider would have little reason to help in this research.

One could also monitor the over the air signaling channels of the competing TDMA/Analog mobile operator to determine the ESN (electronic serial number) of the mobile phone. This would need to be compared to the mobile manufacturer's database of these serial numbers to determine the functionality of the mobiles. The WDVS could also be made portable so it could easily be mounted and relocated as the needs dictated

The major problem with the proposed business solution is the GSM wireless service is still relatively new for mobile operators in the United States, and although the mobile operators have begun to provide their customers with GSM mobile handsets, there still may not be sufficient number of mobile subscribers with GSM equipped handsets in or roaming through lower traffic density markets to justify the cost of conversion to the new GSM standard. Currently, due to the mobile nature of the wireless service offering, there is not a reliable method of determining what type of handsets are in the market or are traveling through the market. This problem is compounded by the mobile operators providing their users with dual mode or even tri mode wireless handsets; e.g., TDMA, Analog, and GSM. Often these handsets-use an existing network when they could have been on the GSM network if it were available.

Once the count of GSM equipped mobiles has been determined by the WDVS, basic traffic assumptions could be used to roughly determine the potential GSM traffic in a particular area. Since a GSM mobile registers on a new system using its MSISDN (telephone number), the home wireless provider can be determined. This allows anticipated demand for different types of GSM services to be gauged before investing in the capital, manpower, and time to construct an entire GSM system.

This system allows an operator to determine the market demand for an advanced technology such as GSM before making the investment in infrastructure. As stated above there are other methods for a single mobile operator to determine the potential demand for their customers, however, this invention allows the data from several mobile operators' customers to be compiled and analyzed. With the above stated invention, a company can easily investigate the possibility and profitability of network infrastructure sharing between multiple mobile operators. This system will enable the cost justification needed to deployment of network infrastructure in areas where the traffic might be unknown.

One sufficiently skilled in the art can see how the present invention can be utilized in conjunction with a number of other types of wireless networks beyond the preferred implementation with a GSM system. Once familiar with the present invention one skilled in the art could apply this invention to CDMA, WCDMA, EDGE, IEEE 802.11, IEEE 802.16/20 (with mobility) or any other wireless network offering some element of mobility.

One skilled in the art can also see how the present invention can be further extrapolated to determine wireless demand in a wireless network where infrastructure has already been deployed. This type of deployment would allow a wireless network system operator to cost justifies a network base station or cell site before it was constructed. The present invention utilized in an existing network would also allow a, tower or structure owner to demonstrate the desirability of their location over another structure in the same area or alternatively the present invention can be used to help a wireless network operator to optimally site their facilities before the final wireless network infrastructure commitment was made.

In the following description, for purposes of explanation and not limitation, specific details are set forth such as particular embodiments, network architectures, techniques, components, etc. in order to provide an understanding of the present invention. However, it will be apparent to those skilled in the art that the present invention may be practiced in other embodiments that depart from these specific details. In certain instances, detail descriptions of well known methods, interfaces, devices, protocols, and signaling techniques are omitted so as to not obscure the description of the present invention with unnecessary detail.

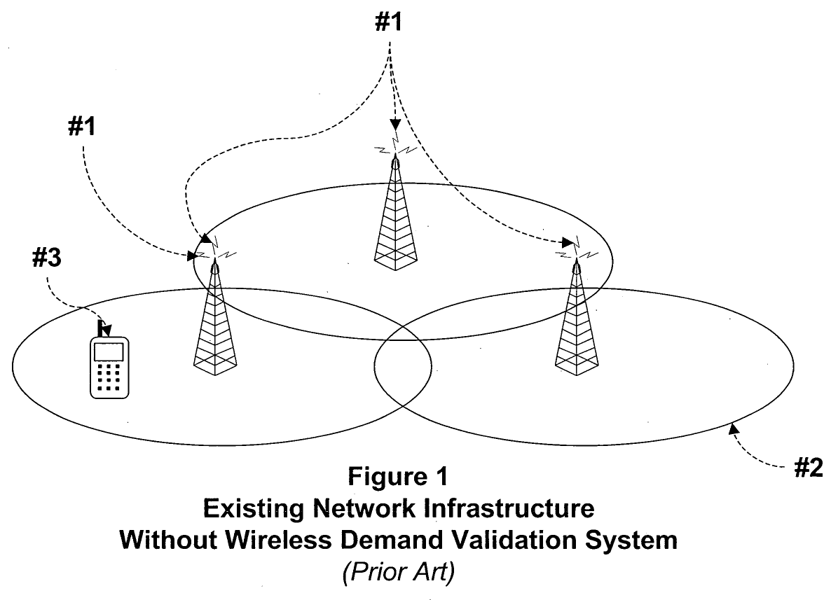

Turning now to the figures, in which like numerals identify similar elements in the several figures, FIG. 1 illustrates a conventional wireless communications network in which the presence of a wireless device 3 is know by an individual base station 1 or a plurality of base stations, as represented by the base station 1a. The presence is first detected when the wireless device 3 first enters the coverage area of the wireless network 2, detects the presence of radio frequency energy, determines the radio frequency is originating from a wireless network 2 which the wireless device 3 desires to register its presence and possibly establish communications with, and therefore, among other things, the wireless device 3 sends a registration signal to the individual wireless base station la to establish the wireless device's 3 presence in the coverage area of the wireless network 2. In this manner the wireless device 2 can be registered on the network, validated, and communications destine for the wireless device 3 can be efficiently routed to the wireless device.

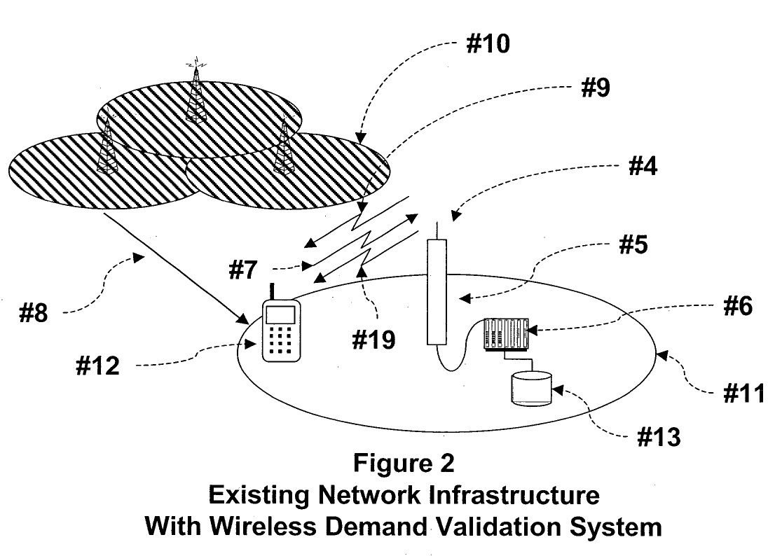

When wireless network operators have not deployed wireless infrastructure in an area the presence of a wireless devices are usually unknown and exceedingly difficult to determine. In FIG. 2 a wireless demand validation system 6 which comprises of a test radio 14, applications processor 15, communications interface 16, registration storage database 17 and a computer system 18. The wireless demand validation system 6 as disclosed in the present invention is located in an area 11 the wireless network operator desire to determine demand for one or all of the services offered by the wireless network operator. The wireless demand validation system 6 is shown located adjacent to a temporary structure 5 with an antenna 4 mounted on top of the temporary structure 5. However the wireless demand validation system 6 could be easily located on an existing tower structure, roof top, or any other existing structure that provides a view of the area where the wireless network operator desires to determine demand.

As a wireless device 12 moves 8 out of the coverage area of the existing wireless network 10 and no longer receives signals from wireless network 10, it begins a process of determining the presence of a new wireless network. When the wireless device 12 locates a signal from a new wireless network 9 the wireless device 12 determines if registration and possibly communications with this network is desirable. If the wireless device 12 so determines communications is desirable, the wireless device 12 will send some type of registration signal 7 to the wireless network. In FIG. 2, the wireless device 12 is actually communicating with a wireless demand validation system 6, according to an embodiment of this invention. This wireless demand validation system 6 receives the registration signal 7 from the wireless device 12 and instead of following the normal procedures of registering said wireless device 12 onto a wireless network, the wireless demand validation system 6 stores the data specific to the wireless device 12 and the attempted contact with the network into database 13. The wireless demand validation system 6 then sends a signal to the wireless device 12 instructing it that communications with the network is not possible or desirable. The wireless device 12 will then begin looking for an alternative wireless network where service is possible or desirable. Alternatively the wireless demand validation system 6 can send a second query message 19 to the wireless device 12 requesting more information from the wireless device 12. This second query message 19 can be repeated several times until the wireless demand validation system 6 obtains all of the desired information corresponding to the wireless device 12. The wireless demand validation system 6 then sends a signal to the wireless device 12 instructing it that communications with the network is not possible or desirable. The wireless device 12 will then begin looking for an alternative wireless network where service is possible or desirable.

Once the wireless demand validation system 6 has the information on the wireless device 12 stored in the database 13 this information can be further processed and analyzed against other databases that contain information about the wireless device such as a wireless clearing house 24 or a credit report server 20. The information on the wireless device 12 stored in the database 13 can be further analyzed against know utilization patterns, as described in the current invention. The host computer 18 can communicate with the other databases 20 through any number of means including the public switched telephone network 22, internet 21, wireless network 23 or any other communications facilities or network. This will allow the wireless network operator to predetermine any demand for wireless services before the costly step of installing wireless infrastructure.

The wireless demand validation system 6 can be mounted on existing tower structures 25 to determine the anticipated demand of users 26 before a network provider makes the decision of which tower structure to deploy network infrastructure. This would allow the network operator to best deploy their network capital to server the demand of existing users 26. This would also allow tower structure owners to effectively market their tower structures to wireless operators.

In view of the foregoing, it will be appreciated that present invention provides significant improvements in systems for measuring the market potential for wireless services and that numerous changes may be made therein without departing from the spirit and scope of the invention as defined by the following claims.

The invention claimed is:

1. A wireless demand validation system for assessing market potential for wireless service within a service area, comprising:
a wireless test radio configured to mimic the air interface of a wireless communication system interface by transmitting autonomous registration signals to wireless units within the service area, and by receiving registration messages from responding wireless units within the service area;
a database configured to store information associated with the registration messages; and
a host computer system configured to analyze the information stored in the database to determine the market potential for wireless service within a service area.

2. The wireless demand validation system of claim 1, wherein the test radio is further configured to transmit a query message to a responding wireless unit to obtain additional information about the responding wireless unit.

3. The wireless demand validation system of claim 1, wherein the host computer system is further configured to use the information received from a responding wireless unit to obtain additional information about the responding wireless unit from an information source other than the wireless unit.

4. The wireless demand validation system of claim 3, wherein the host computer system communicates with the information source over the wireless system, a public switched telephone network, a data network, or the Internet.

5. The wireless demand validation system of claim 3, wherein the information source comprises a wireless system clearinghouse.

6. The wireless demand validation system of claim 3, wherein the information source comprises a credit report server.

7. The wireless demand validation system of claim 1, wherein the database stores records for each responding device indicating a directory number, equipment identifier, a home system identifier, and most recent registration identifier associated with the responding wireless unit.

8. The wireless demand validation system of claim 1, wherein the test radio is further configured to cause a responding wireless unit to seek registration with a different wireless system after receiving the registration message from the responding wireless unit.

9. The wireless demand validation system of claim 1, wherein the test radio causes the responding wireless unit to seek registration with a different wireless system by transmitting a message indicating that wireless service is not available through the test radio.

10. A method of assessing market potential for wireless service within a service area, comprising the steps of:
deploying a wireless test radio configured to mimic the air interface of a wireless communication system interface;
transmitting autonomous registration signals from the test radio to wireless units within the service area;
receiving registration messages from responding wireless units within the service area;
storing information associated with the registration messages in a database; and
analyzing the information stored in the database to determine the market potential for wireless service within a service area.

11. The method of claim 10, further comprising the step of transmitting a query message to a responding wireless unit to obtain additional information about the responding wireless unit.

12. The method of claim 10, further comprising the step of using the information received from a responding wireless unit to obtain additional information about the responding wireless unit from an information source other than the wireless unit.

13. The method of claim 12, further comprising the step of communicating with the information source over the wireless system, a public switched telephone network, a data network, or the Internet.

14. The method of claim 13, wherein the information source comprises a wireless system clearinghouse.

15. The method of claim 13, wherein the information source comprises a credit report server.

16. The method of claim 10, wherein the database stores records for each responding wireless device indicating a directory number, equipment identifier, a home system identifier, and most recent registration identifier associated with the responding wireless unit.

17. The method of claim 10, further comprising the step of causing a responding wireless unit to seek registration with a different wireless system after receiving the registration message from the responding wireless unit.

18. The method of claim 10, further comprising the step of transmitting a message to a responding wireless unit indicating that wireless service is not available through the test radio.

19. A method of assessing potential base station locations for wireless service, comprising the steps of:
deploying a wireless test radio configured to mimic the air interface of a wireless communication system interface at a first potential base station location;
transmitting autonomous registration signals from the test radio at the first potential base station location to wireless units;
receiving a first set of registration messages from responding wireless units;
storing information associated with the first set of registration messages in a database;
deploying the wireless test radio at a second potential base station location;
transmitting autonomous registration signals from the test radio at the second potential base station location to wireless units;
receiving a second set of registration messages from responding wireless units;
storing information associated with the first set of registration messages in a database; and
analyzing the information stored in the database to determine whether the first or second potential base station location is a preferred base station location.

20. The method of claim 19, further comprising the step of causing each responding wireless unit to seek registration with a different wireless system after receiving the registration message from the responding wireless unit.
